(19) United States
(12) Patent Application Publication
(10) Pub. No.: US 2007/0211208 A1
(43) Pub. Date: Sep. 13, 2007

(54) Eyeglasses

(76) Inventors: Elizabeth Cunningham, Toronto (CA); David Allen Cunningham, Toronto (CA)

Correspondence Address: LEDGLEY LAW, 111 RICHMOND STREET WEST, SUITE 905, TORONTO, ON, M5H-2G4, US

(21) Appl. No.: 11/700,189

(22) Filed: Jan. 31, 2007

Related U.S. Application Data
(60) Provisional application No. 60/780,857, filed on Mar. 10, 2006.

(51) Int. Cl. G02C 5/00

(52) U.S. Cl. 351/41

(57) ABSTRACT

A frame for eyeglasses to facilitate access to one or both eyes of a user, for various purposes such as the application of makeup, dispensing of medications, and unhindered access to the user's face.

The access to the user's face is unhindered by the frame of the eyeglasses when the lens is rotated from a first upright position to a second down turned position and the lower frame portion wraps around to form side arms without substantially deviating from the axis line defined by the lower frame portion in the wrap around portion of the frame thereby allowing unhindered access by a user's hand while still being able to view through the un-rotated lens portion which remains in a substantially vertical position to allow the user to see through this un-rotated lens.

The eyeglasses of the present invention comprise one or more (typically two) moveable lens portions which rotate around an axis defined by a lower frame portion of the eyeglass frames. The eyeglasses have a narrow “inter-lens” distance which permits a user to lower a lens away from one eye, for access, while still seeing clearly through the other lens portion covering the user's second eye, including visualization of the first uncovered eye.

A method of applying makeup using the eyeglasses of the present invention. The method comprising the step of rotating one lens holding frame portion, around an axis line defined by said lower frame portion and accessing an eye to apply makeup while viewing the makeup application through the remaining upright lens.

### FIELD OF THE INVENTION

This invention relates to eyeglasses. More specifically, this invention relates to a frame for eyeglasses which facilitate access to the eye for various purposes including the application of makeup, the dispensing of medications, and other uses. The present invention further relates to eyeglasses with frame portions which individually can move away from each eye to permit access to one eye while the other eye is still able to use at least one lens of the eyeglasses.

### BACKGROUND OF THE INVENTION

Eyeglasses with drop down lenses are known in the prior art. However, in the market place at present there are no eyeglasses which are able to provide easy access to one eye individually, or both eyes, for the application of make up or other uses without the hindrance of hitting an arm of the frame or having to remove the eyeglasses entirely away from the face.

In prior art glasses the temple hinges are raised along the side of the lenses. The raised temple hinges, and the frame arm extending therefrom, create an obstacle to access the eye from the side even in those prior art frames with lenses which are moveable away from one or both eyes; also referred to herein as “dropdown lenses. This creates an obstacle preventing free movement of a hand to dispense or apply medicine or makeup and access to the eye in these circumstances can cause dispensing errors and possibly even injury to the eye by involuntary hand movements caused by the temple hinge and arm obstacles.

For example, in prior art eyeglasses with raised temple hinges the user must come from the front to apply, for example make-up. In the application of eyeliner, even in prior art eyeglasses, the temple hinge and arms create an obstacle for the hand when holding a make up brush or applicator.

### SUMMARY OF THE INVENTION

In accordance with an aspect of the present invention there is provided eyeglasses comprising a frame portion and a first lens portion said first lens portion being moveably connected to said frame portion such that said at least one lens portion can be moved from a substantially upright position to a substantially down turned position and said frame portion wraps around from the front of said eyeglasses to sides of said eyeglasses in substantially the same place to initiate side arm portions of said eyeglasses.

In accordance with another aspect of the present invention the eyeglasses further comprise a second lens portion In accordance with another aspect of the present invention the second lens portion is rotatable from a first substantially upright position to a second turned down or downturned position.

In accordance with another aspect of the present invention the down turned position is achieved by rotation from said first substantially upright position through an angle of about 180 degrees to said second turned down position.

In a preferred embodiment the rotation occurs through the use of a hinge which provides rotation therethrough.

In accordance with another aspect of the present invention the eyeglasses frame portion wraps around the side of the eyeglasses to form a wrap around portion which is continuous between a lower frame portion of said overall fame and side portions (arms) of the eyeglasses.

In accordance with another aspect of the present invention the arms comprise a first end proximal to the lens portions of the eyeglasses and a second, opposite end distal from the lens portions of the eyeglasses wherein said distal portion is adapted to fit a user's ear. Therebetween said first proximal and said second distal end of said side are is a mid-region portion which changes in elevation rising from the plane of the lower frame portion upwards to a level where the side arm will suitably fit over a users ear thereby eliminating any side arm extending from the midpoint of the lens portions as is present in most eyeglasses. Instead the side arm begins from the wrap around portion of the lower frame and only in the mid-region does it begin to rise in height to the level of a users ear. This allows a person to insert without hindrance their hand above the proximal first end of the side arm.

In accordance with another aspect of the present invention two lens portions are individually hingeably rotational along an axis defined by a lower frame portion of said eyeglasses frame.

In accordance with another aspect of the present invention frame portion comprises a bridge wherein said bridge and said lens portion, in combination, define a gap ranging from about 0.5 mm to about 2.5 mm.

In accordance with another aspect of the present invention the gap ranges from about 1 mm to about 2 mm.

In accordance with another aspect of the present invention the eyeglasses bridge comprises a midpoint portion and the mid portion is about 13 mm across.

In accordance with another aspect of the present invention the eyeglasses further comprising defined lens-holding frame portions surrounding and securing said lens portions.

In accordance with another aspect of the present invention the eyeglasses lens-holding frame portions further comprise a break.

In accordance with another aspect of the present invention the eyeglasses lens-holding frame portions break further defines a break point secured by a securing means.

In accordance with another aspect of the present invention the securing means is a nut and bolt, screw and screw threads, flexible wire tied through an opening, a nail placed through an opening or a spring or other suitable equivalent.

The break point permits the replacement of a lens easily into the same frames. The lenses in the eyeglasses of the present invention may be of the same prescription or diopter or may be different according to each of the user's eyes.

In accordance with another aspect of the present invention, there is provided a method of applying makeup using the eyeglasses of the present invention comprising the step of rotating one lens holding frame portion, around an axis line defined by said lower frame portion and accessing the uncovered eye to apply makeup while viewing the makeup application through the remaining eye which is covered by the remaining upright lens.

### BRIEF DESCRIPTION OF DRAWINGS

Other and further advantages and features of the invention will be apparent to those skilled in the art from the following detailed description of the preferred embodiments of the invention taken together with the accompanying drawings.

For the purpose of illustrating the invention, there is shown in the drawings a form which is presently preferred; it being understood, however, that this invention is not limited to the precise arrangements and instrumentalities shown.

In the accompanying drawings:

FIG. 1 is a front perspective view of an embodiment of the present invention;

FIG. 2 is a front elevational view of an embodiment of the present invention.

FIG. 3 is a top perspective view of an embodiment of the present invention.

FIG. 4 is an enlarged view of an embodiment of the present invention illustrating one lens frame portion and movement from a first to a second position.

FIGS. 5A and 5B depicts a side elevation view of two embodiments of the present invention

FIG. 6 illustrates an eyeglass frame of an embodiment of the present invention, in use.

FIG. 7 illustrates an eyeglass frame of an embodiment of the present invention, in use.

FIGS. 8A, 8B and 8C illustrate an embodiment of the present invention where the frame around each eyepiece can be opened or closed using a closing means for example a screw to permit ready replacement of the lens.

FIG. 9 illustrates dimensions for a preferred embodiment of an eyeglass frame of the present invention.

### DETAILED DESCRIPTION OF THE INVENTION

A frame for eyeglasses to facilitate access to one or both eyes of a user, for various purposes such as the application of makeup, dispensing of medications, and unhindered access to the user's face.

The access to the user's face is unhindered by the frame of the eyeglasses when the lens is rotated from a first upright position to a second down turned position and the lower frame portion wraps around to form side arms without substantially deviating from the axis line defined by the lower frame portion in the wrap around portion of the frame thereby allowing unhindered access by a user's hand while still being able to view through the un-rotated lens portion which remains in a substantially vertical position to allow the user to see through this un-rotated lens.

The eyeglasses of the present invention comprise one or more (typically two) moveable lens portions which rotate around an axis defined by a lower frame portion of the eyeglass frames. The eyeglasses have a narrow “inter-lens” distance which permits a user to lower a lens away from one eye, for access, while still seeing clearly through the other lens portion covering the user's second eye, including visualization of the first uncovered eye.

A method of applying makeup using the eyeglasses of the present invention. The method comprising the step of rotating one lens holding frame portion, around an axis line defined by said lower frame portion and accessing an eye to apply makeup while viewing the makeup application through the remaining upright lens.

The eyeglasses of the present invention solve a problem that many women, and also some men, experience when trying to apply eye makeup and perform other up-close applications to their face. The problem arises when trying to access their eyes and/or their face and see clearly what they are doing at the same time. Normally this would require getting very close to a mirror. For those who already wear glasses, there is the additional obstruction created by the frames of the glasses themselves.

The eyeglasses of the present invention are suitable for persons who already have prescription lenses. They can equally be used by persons who do not use prescription lenses. In the latter instance the user simply requires or desires the benefit of some magnification to facilitate face applications.

In the eyeglasses of the present invention, the lenses are closer together than in regular prescription or reading glasses, thereby providing a clear view and access to the other eye and which is further facilitated by magnification provided by the one lens in use. There is no frame interference using the eyeglasses of the present invention because of the horizontal wrap-around design of the frame at the front of the eyeglasses. In addition, the lenses are set close to the nose to allow a clear view across to the opposite eye.

The lenses in the eyeglasses of the present invention drop down completely allowing full access to each eye and full view of vanity items that may be used by an individual applying makeup or medicines to the face or eyes.

Important design features of the eyeglasses of the present invention is the full access to the opposite eye because of the various improvements present in the eyeglasses of the present invention.

Varying strengths of magnification or prescription would be available to users. Prescription lens users could go to their optometrist to get a suitable prescription for each of the lenses. Preset magnifications could also be sold off the shelf. Standard magnification diopters are 2.5, 3, 3.5, and 4 for “off the shelf” models. It is recommended to use 1 strength stronger than a regular prescription if the user has a prescription. If you have one eye different from the other, an optician can easily pop a different lens into either side.

Each lens drops completely out of the way to allow access to the eye. Proper magnification prevents leaning too far in to the mirror and hitting the mirror or eye with a pencil or other instrument or medicine container.

In accordance with an aspect of the present invention, the eyeglasses of the present invention provide a substantially unobstructed access to one eye or both eyes from the side of the head in the temple region. The eyeglasses of the present invention further provide at least one lens which drops down away from the eye.

One advantage of the eyeglasses of the present invention is that the “lens to nose” distance is less than in prior art eyeglass frames. An advantage of this proximity between the lens and the nose, in this embodiment is the facility for one eye to see with prescriptive correction while the other eye receives treatment or is accessed for treatment or make-up application By reducing the distance between the lens and the nose with its prescriptive lens still in place, access to at least one eye is facilitated because the other eye can still see clearly during application or treatment.

An additional benefit of reducing the reliance on and, at times, the need for a mirror is also provided.

In accordance with another aspect the eyeglasses of the present invention are provided with pre-set levels of magnification in one or more lenses. In accordance with another aspect of the present invention, the frame of the eyeglasses is adapted to receive prescriptive lenses as prescribed by an optometrist or ophthalmologist.

In accordance with another aspect, the eyeglasses of the present invention are generally straight or flat across the front of the eyeglass lenses. In another embodiment, the lenses are curved the front frame has a curvature to it as well. In a preferred embodiment of the present invention, there is provided eyeglasses having 1-2 mm between the side of the lens frame portion and the side of the bridge.

The eyeglasses of the present invention can be used advantageously for the application of make-up, medical treatments of one or both eyes, areas on the face in the eye region, placing drops in one or both eyes, and for hobbies such as needle point.

In accordance with another aspect of the present invention the eyeglass frames provide ease of access to the surrounding areas of the eye which otherwise are restricted by the presence of the eyeglass frames. Haircutting, treatments of the face or application of makeup in the areas surrounding the eyes are facilitated.

For teenagers, or other persons with blemishes, for example, the eyeglasses of the present invention would permit viewing of the blemish while at the same time applying a treatment to it.

In addition to the use of the eyeglasses of the present invention are also useful for personal grooming such as removal of facial hair including nose hairs, chin hairs, moustache trimming. The glasses are suited for young and old, men and women alike. They may be considered a type of assistive device for persons with disabilities who may not be able to easily remove or put on a pair of glasses.

The eyeglasses of the present invention are suitable for any person who works at a computer require special bifocals or trifocals. The eyeglasses of the present invention provide an alternative to bifocals and trifocals as the user.

Turning to the Figures, the glasses of the present invention have a temple hinge portion which is set further back on the side of the head than in prior art eyeglasses.

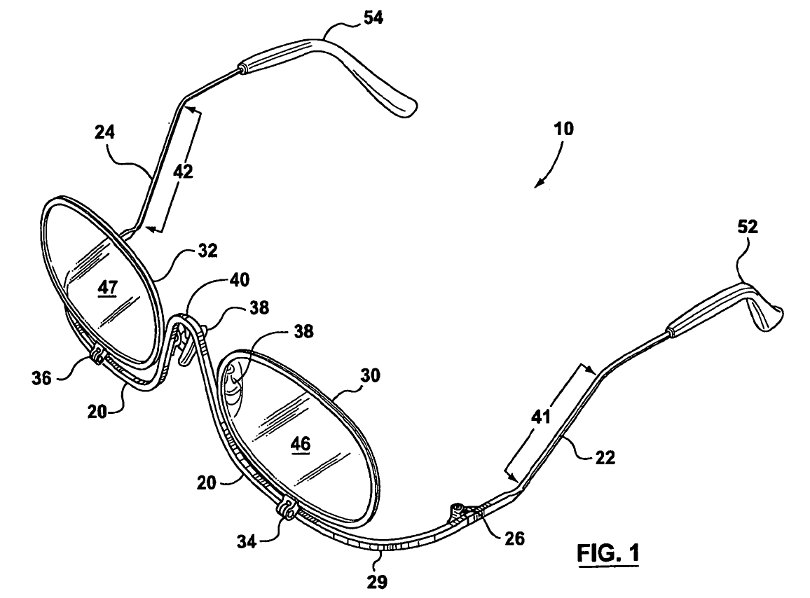

Aside from the bridge, a frame portion 20 of the glasses from hinge 26 to hinge 28, as seen in FIG. 1 in front view, lies entirely below the lenses.

Preferred embodiments of the eyeglasses, also referred to as glasses, of the present invention are illustrated in the accompanying Figures. Turning to FIG. 1, in a preferred embodiment of the present invention, there is illustrated a pair of eyeglasses, 10, having a frame element 20 which extends below lenses 46 and 47 and extends on either side posterior to temple hinges 26 and 28 as frame arms 22 and 24. Lens 46 and 47 are encompassed by frame portions 30 and 32 and are connected to the frame element 20 by hinges 34 and 36.

The eyeglasses 10 have two nose pieces 38 and a bridge 40.

Frame 20 extends from temple hinge 26 along the front of the eyeglasses 10 extending under the frame portions 30 and 32.encompassing lenses 46 and 47, along to temple hinges 26 and 28. The lenses 46 and 47 are optionally present although in use the lenses are typically in place.

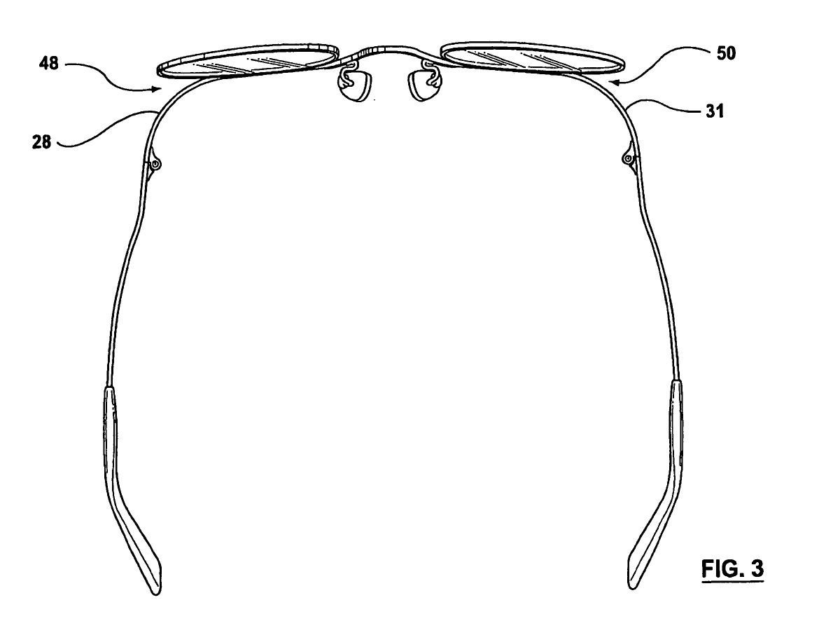

As illustrated in FIG. 1, the frame 20 extends substantially posterior to the plane of the glasses in a curved fashion passing through curvature, 29 and 31 (see FIG. 3) before it reaches temple hinges 26 and 28.

The sweeping, curved frame at curvatures 29 and 31 and the substantially posterior position of temple hinges 26 and 28 (as compared to the plane of the lenses) help to create a substantially open area 48 or 50 at the side of each lens, 46 and 47, respectively. In addition the frame 20 connects at temple hinges 26 and 28 keeping level without turning upwards, as occurs in prior art frames. By keeping level at the temple hinges and having the frame wrap underneath the lenses, open areas 48 and 50 are further unencumbered by any parts of the eyeglass frame.

Frame arm portions 22 and. 24 extend posteriorly from temple hinges 26 and 28 respectively.

In regions 41 and 42 the arms 22 and 24 turn upwards to reach ear level where the plateau terminating in ear pieces 52 and 54. Notably the change in height of the frame arms 22 and 24 occurs posterior to the temple hinges 26 and 28.

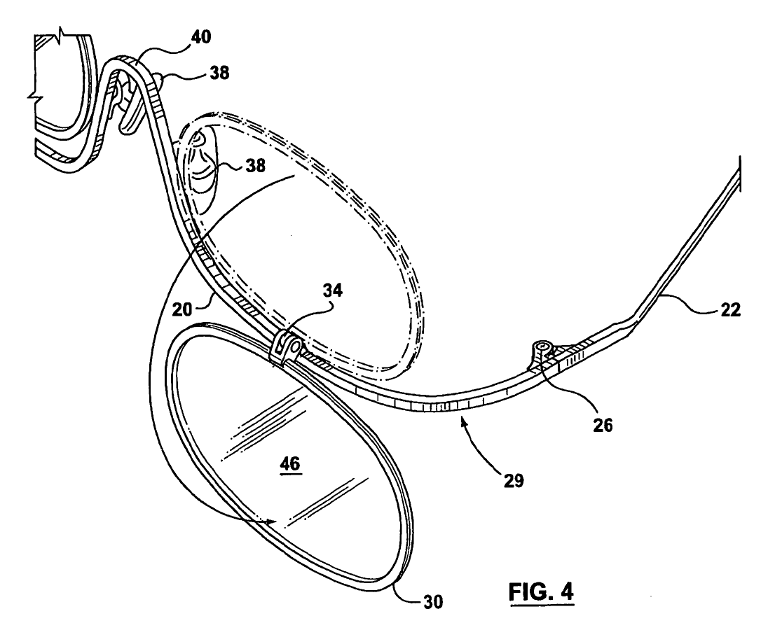

In use, the eyeglasses 10 of the present invention have moveable lens frame portions 30 and 32 which move between a first up position as shown in dot-dash lines in FIG. 4 to a second down position also illustrated in FIG. 4.

In the preferred embodiment illustrated in the Figures, the lens frame portions 30 and 32 are connected to the lower frame portion 20 by a rotating means. In the preferred embodiment illustrated in the Figures the rotating means are hinges 34 and 36 respectively. It is understood that other means of moveably rotating the lenses around a lower frame portion would be understood to a person skilled in the art.

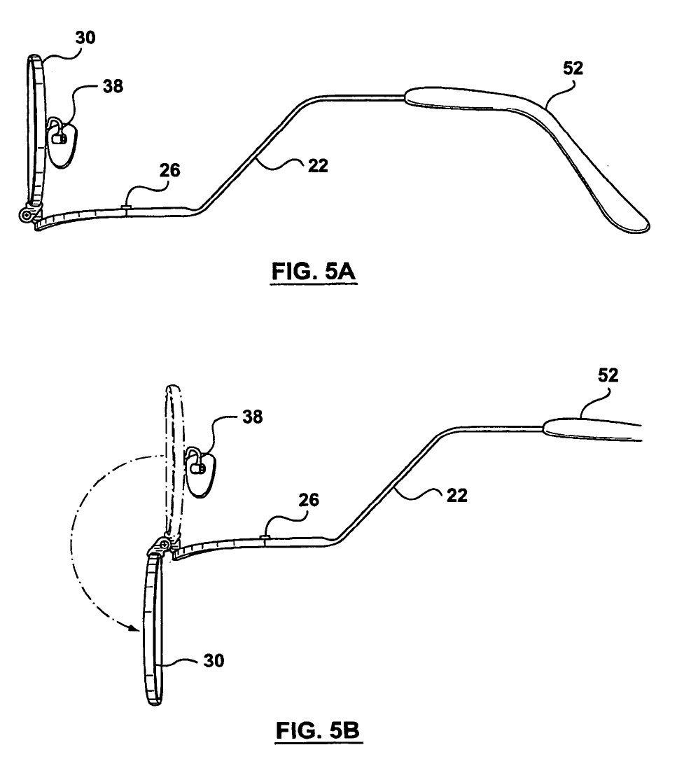

FIG. 5 further illustrates the lens frame portion in the up position (A) and the down position (B).

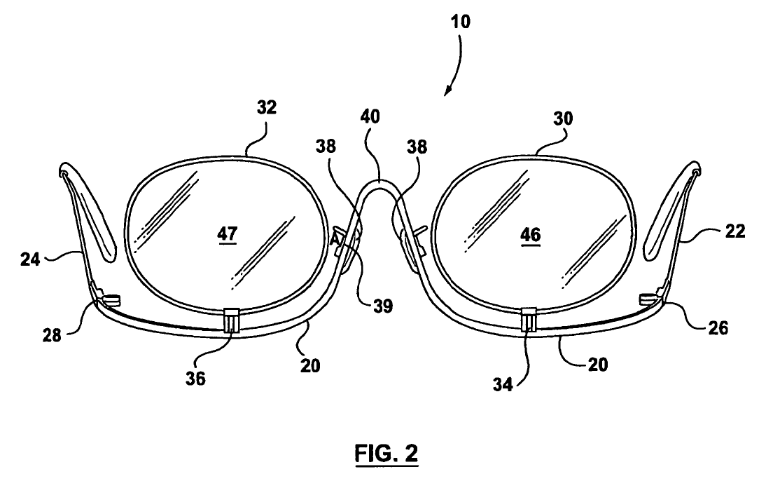

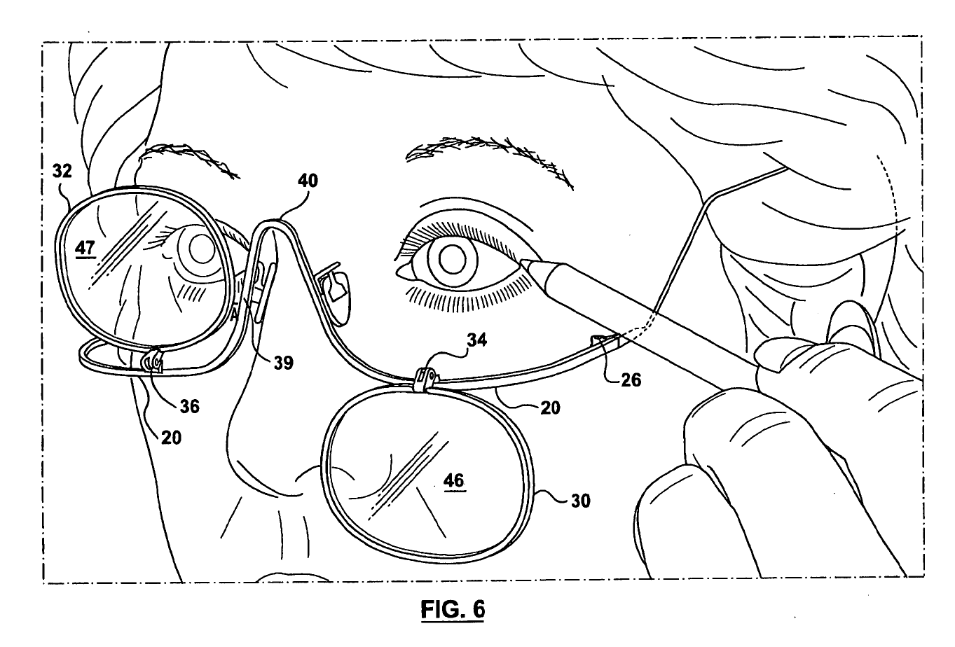

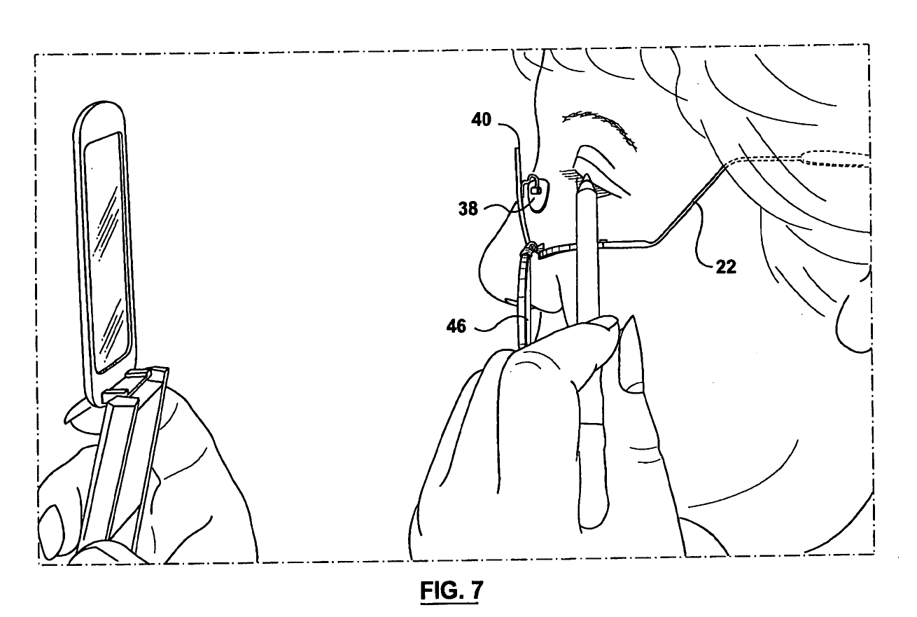

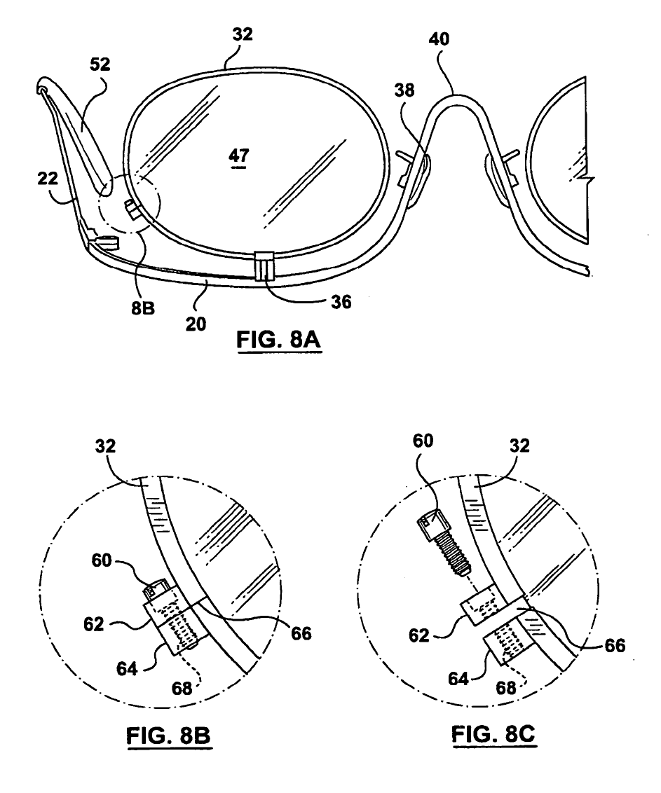

FIGS. 6 and 7 illustrate the eyeglass frame in use as a pair of eyeglasses on a user's face. FIG. 6 further illustrates gap A between the lens fame portion 32 and the upward frame rise 39 of the bridge 40. This same gap A is illustrated in FIGS. 2 and 8. As noted in FIG. 8, gaps A and B are 1 to 2 mm in a preferred embodiment of the invention. In the inventive eyeglass frame of the present invention this space permits the user to be able to easily look through the lens 47, as shown in FIG. 6, when lens 46 is in the dropped down position.

FIGS. 6 and 7 illustrate how the eyeglass frame of the present invention can be used in the application of makeup. These Figures clearly show the absence of encumbrance or obstruction from the side of the lens to permit an eyebrow pencil, for example, to easily, comfortably and securely be used by the use of the eyeglasses.

At the same time, the user is able to look through lens 47 when lens 46 is moved into the down position. Similarly; the lens 47 could be in the down position and lens 46 in the up position to permit viewing during application of makeup on the opposite side.

The user is able to apply the makeup to one eye without loss of vision. This facilitates make up application as the user can stand at a normal distance from the mirror since they can continue to use at least one prescriptive lens during the application.

FIGS. 8A, B and C illustrate an embodiment of the present invention. In FIGS. 8A, B and C an embodiment is shown where the lens holding frame portion 32 is detachable along a break point such as 66. A securing means such as a screw, bolt, spring, pin, nail, flexible wire, flexible string, or other equivalents known to persons skilled in the art, secures the frame together across the break point. In FIGS. 8A, B and C a threaded small screw is used, for ample.

FIG. 8B illustrates in an enlarged view the frame with the securing means, screw 60, in a tightened position so the frame around the lens is fully closed.

FIG. 8C illustrates the frame 32 broken along break line 66 with screw 60 removed and screw threading portions 62 and 64 attached to either side of said break point 66 on said frame 32. The threading 68 is illustrated as being present inside said screw threading portions 62 and 64.

### EXAMPLE

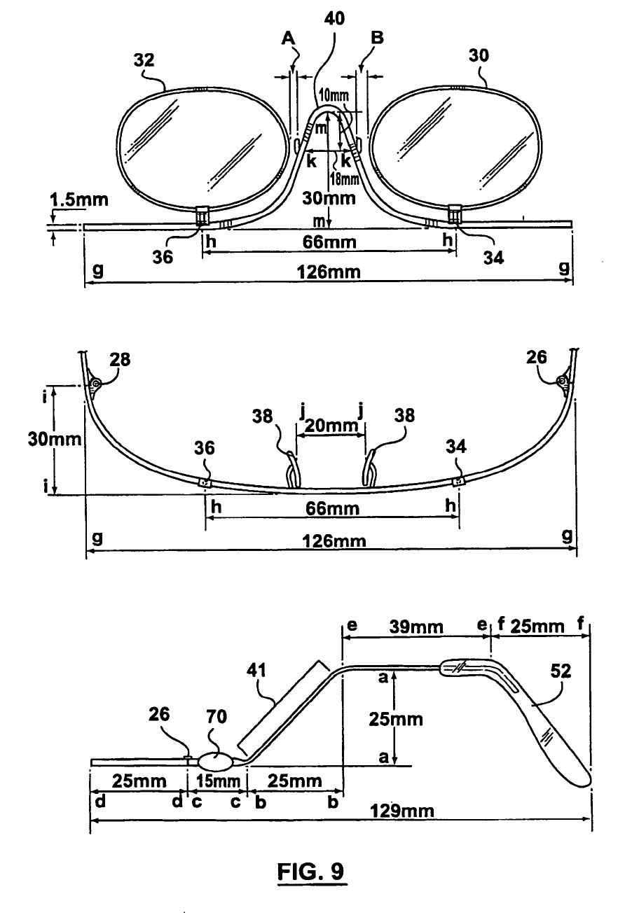

FIG. 9 illustrates preferred dimensions in three views of the eyeglasses in a particularly preferred embodiment. The proximity of the lens frame portions, and hence the lenses, to the bridge 40 of the eyeglasses makes it easier to see and provides a better line of vision for viewing.

FIG. 9 sets out specific measurements for one preferred embodiment of the eyeglass frames of the present invention. In the front view the distance at the approximate mid-point of the bridge portion of the frame is approximately 13 mm.

FIG. 9 is an illustration of dimensions of one example of the eyeglasses of the present invention. These dimensions are preferred dimensions however FIG. 9 represents only one possible exemplification of the present invention.

FIG. 9 sets out preferred distances along lengths a-a, b-b, c-c, d-d, e-e, f-f, g-g, h-h, i-I, j-j, k-k, and m-m.

Reference numeral 70 provides for an optional expended arm portion or plate upon which a trade-mark could be engraved or mounted.

Although preferred embodiments of the invention have been described herein, it will be understood by those skilled in the art that variations, modifications and equivalents may be made without departing from the spirit or scope of the invention as defined in the appended claims.

What is claimed is:

1. Eyeglasses comprising a frame portion having a nose piece and a first lens portion said first lens portion being moveably connected to said frame portion such that said at least one lens portion can be moved from a substantially upright position to a substantially down turned position and said frame portion wraps around from the front of said eyeglasses to sides of said eyeglasses in substantially the same place to initiate side arm portions of said eyeglasses.

2. The eyeglasses according to claim 1 further comprising a second lens portion.

3. The eye glasses according to claim 2 wherein said second lens portion may also be rotated from a substantially upright position to a down turned position.

4. The eyeglasses according to claim 3 wherein said down turned position is achieved by rotation from said substantially upright position of about 180 degrees.

5. The eyeglasses according to claim 4 wherein said rotation occurs by means of a hinge.

6. The eyeglasses according to claim 5 wherein said frame portion wraps around to form side arms of said eyeglasses.

7. The eyeglasses according to claim 6 wherein said arms have a first end near said lens portion and a second, opposite end, adapted to fit a user's ear.

8. The eyeglasses according to claim 7 wherein said first and of said side arm portion is in substantially the same plane as said wrap around frame portion and contiguous with said wrap around frame portion.

9. The eyeglasses according to claim 8 wherein said side arm portion compromises a mid portion between said first end and said second end said mid portion further comprising a gradual rise from said first end to second end such that said second end is higher than said first end.

10. The eyeglasses according to claim 9 wherein said two lens portion are individually hingeably rotational along an axis defined by a lower frame portion of said frame portion.

11. The eyeglasses according to claim 10 wherein said frame portion comprises a bridge wherein said bridge and said lens portion, in combination, define a gap ranging from about 0.5 mm to about 2.5 mm.

12. The eyeglasses according to claim 11 wherein said gap ranges from about 1 mm to about 2 mm.

13. The eyeglasses according to claim 12 wherein said bridge comprises a midpoint portion of about 13 mm.

14. The eyeglasses according to claim 13 further comprising defined lens-holding frame portions surrounding and securing said lens portions.

15. The eyeglasses according to claim 14 wherein said lens-holding frame portions further comprise a break.

16. The eyeglasses according to claim 15 wherein said break defines a break point secured by a securing means.

17. The eyeglasses according to claim 16 wherein said securing means is a nut and bolt, screw and screw threads, flexible wire tied through an opening, a nail placed through an opening or a spring.

18. The eyeglasses according to claim 17 wherein said lower frame portion further comprises a wrap around portion joining said lower to said side arms along a common plane.

19. The eyeglasses according to claim 18 wherein said common plane extends along an axis line defined by said lower frame portion and does not rise above said axis line as it continues to form said side arms for a distance of about 25 mm along said first, lens-end, of said side arm portion.

20. A method of applying makeup using the present invention comprising the step of rotating one lens holding frame portion, around an axis line define by said lower frame portion and accessing an eye to apply makeup while viewing the makeup application through the remaining upright lens.
